(19) United States
(12) Patent Application Publication
(10) Pub. No.: US 2026/0254935 A1
(43) Pub. Date: Aug. 27, 2026

(54) AUTOMATED INTERPUPILLARY DISTANCE DETECTION AND AR DEVICE CALIBRATION SYSTEM

(71) Applicant: Snap Inc., Santa Monica, CA (US)

(72) Inventors: Rina Kang, Playa del Rey, CA (US); Shin Hwun Kang, Los Angeles, CA (US); Mathieu Emmanuel Vignau, Los Angeles, CA (US); Bing Wu, Davie, FL (US)

(21) Appl. No.: 19/062,897

(22) Filed: Feb. 25, 2025

(51) Int. Cl. H04N 13/327; G06F 3/01; H04N 13/344; H04N 13/366; H04N 13/398; H04N 23/12; H04N 23/60; H04N 23/611

(52) U.S. Cl. CPC H04N 13/327; G06F 3/013; H04N 13/344; H04N 13/366; H04N 13/398; H04N 23/12; H04N 23/611; H04N 23/64; H04N 2213/002; H04N 2213/008

(57) ABSTRACT

Techniques are provided for measuring interpupillary distance (IPD) using a mobile device application that integrates with augmented reality (AR) eyewear. The mobile application guides users through a measurement process using the device's camera and sensors to capture facial data. Computer vision algorithms analyze the data to determine IPD measurements while considering facial geometry and depth perception. The system provides real-time positioning feedback and allows manual entry of known IPD values. Measurements are stored in user profiles rather than on AR devices, enabling cross-device synchronization. The integration of IPD measurement into the initial device setup process, combined with flexible measurement options and profile-based storage, provides an accessible solution that maintains accuracy while eliminating the need for specialized measurement hardware.

### TECHNICAL FIELD

The present application relates to the technical field of augmented reality devices and more particularly to systems and methods for measuring and configuring interpupillary distance (IPD) using computing device applications, including mobile computing device applications. Specifically, embodiments of the invention pertain to techniques for using a computing device having an image sensor and computer vision algorithms to measure the distance between the pupils of a user for calibrating augmented reality glasses, thereby optimizing three-dimensional depth accuracy and user comfort in augmented reality experiences.

### BACKGROUND

Advancements in optical display technology, miniaturized sensors, and real-time computer vision processing have led to the development of augmented reality (AR) eyewear capable of seamlessly integrating virtual content with a real-world environment. These head worn devices, which include AR smart glasses and mixed reality (MR) headsets, enhance user experiences by overlaying digital information onto a natural field of view of a user, creating the perception that virtual objects coexist with physical surroundings.

To achieve this effect, AR-based eyewear utilizes specialized display technologies, including waveguides, diffractive optical elements, micro-OLED displays, and laser projection systems, which project virtual imagery into the eyes of a user while allowing visibility of the real-world environment. These displays must be carefully aligned with the line of sight and depth perception cues of the user to ensure that virtual objects appear anchored in three-dimensional space rather than floating unnaturally or distorting user perception.

One critical factor in achieving an immersive and realistic AR experience is the correct alignment of virtual content with the interpupillary distance (IPD)—the distance between the centers of the pupils of the user. IPD varies among individuals, and improper IPD calibration can result in misalignment of the virtual image, distortion, or user discomfort. To address this, many AR eyewear devices require an initial IPD configuration process, where the device is either manually adjusted or automatically calibrated using eye-tracking sensors.

By correctly configuring the IPD, the AR device ensures that virtual content is rendered in a way that aligns with the stereoscopic vision of the user, creating a depth-correct and natural-looking augmentation of the real-world environment. Without proper calibration, virtual objects may appear misplaced, doubled, or cause visual fatigue, reducing the effectiveness of the AR experience.

As AR eyewear technology continues to evolve, improvements in display systems, adaptive optics, and real-time calibration techniques are being developed to enhance comfort, accuracy, and immersion. The present disclosure addresses improvements in these areas to further optimize the alignment, rendering, and visual perception of augmented content in AR-based eyewear.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 is a diagram illustrating components of an augmented reality (AR) system including AR eyewear and a mobile computing device configured to measure interpupillary distance, consistent with some embodiments.

FIG. 2 is a flow diagram illustrating a state machine for use with an application for IPD measurement, including face detection, validation, and calculation states, according to some embodiments.

FIG. 3 is a user interface diagram displaying an initial prompt to estimate eye distance using a mobile device camera, consistent with some embodiments.

FIG. 4 is a user interface diagram providing guidance for removing existing eyewear before measurement, consistent with some embodiments.

FIG. 5 is a user interface diagram showing manual IPD entry options with a default measurement value, consistent with some embodiments.

FIG. 6 is a user interface diagram displaying instructions for face positioning relative to the camera, consistent with some embodiments.

FIG. 7 is a user interface diagram providing feedback to adjust face position further from camera, consistent with some embodiments.

FIG. 8 is a user interface screen providing feedback to adjust face position closer to camera, consistent with some embodiments.

FIG. 9 is a user interface diagram showing the IPD measurement process in progress, consistent with some embodiments.

FIG. 10 is a user interface diagram displaying a completed IPD measurement with editing options, consistent with some embodiments.

FIG. 11 is a user interface diagram showing manual IPD adjustment controls, consistent with some embodiments.

FIG. 12 is a user interface diagram displaying the final IPD measurement confirmation, consistent with some embodiments.

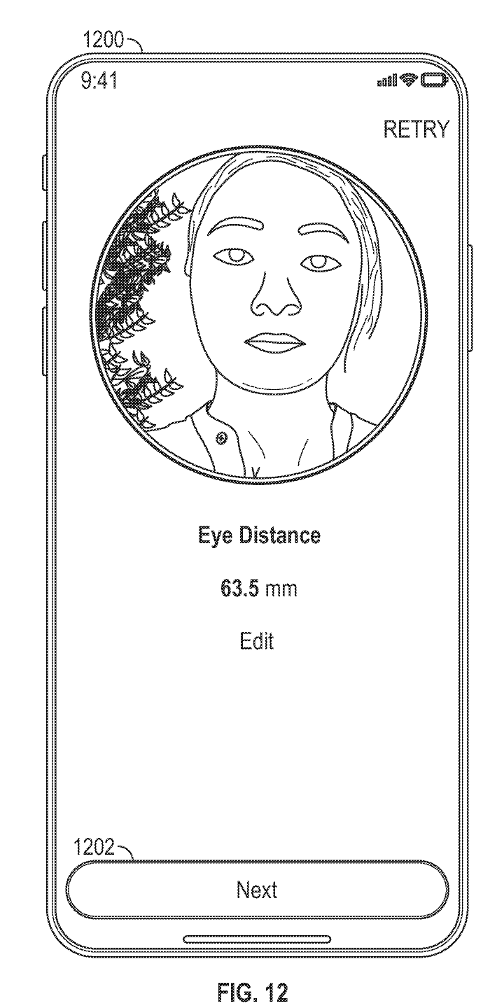

FIG. 13 is a settings interface diagram showing IPD measurement options and controls, consistent with some embodiments.

FIG. 14 is a block diagram illustrating hardware architecture of an AR device, consistent with some embodiments.

FIG. 15 is a block diagram illustrating software architecture of a computing device implementing the IPD measurement system, consistent with some embodiments.

### DETAILED DESCRIPTION

The present disclosure describes systems and methods for measuring and configuring interpupillary distance (IPD) using a computing device application that interfaces with augmented reality (AR) eyewear. Accurate IPD measurement and configuration is critical for properly rendering 3D content at correct depths and creating comfortable viewing experiences. The techniques described herein enable precise measurement of IPD of a user through a guided imaging process, which can then be used to calibrate AR devices for optimal visual experience. For purposes of explanation, specific implementations and technical details are set forth to provide a thorough understanding of the various embodiments. However, it will be apparent to one skilled in the art that these specific details are not required to practice the disclosed embodiments.

Conventional techniques for measuring IPD present several technical challenges that can significantly impact user comfort and accessibility. Traditional manual measurement methods typically require specialized tools, such as pupillometers or PD rulers, which are not commonly available to consumers. Even when these measurement tools are accessible, obtaining accurate measurements requires proper technique and expertise that most users lack, potentially leading to incorrect measurements and suboptimal device configuration.

The technical problems are particularly acute for hand-based user interfaces in AR environments, where IPD miscalibration can substantially increase vergence accommodation mismatch (VAM), creating focal rivalry and user discomfort. For example, users with smaller IPD measurements (e.g., 60mm) may experience hand-based UI elements appearing approximately 3cm closer than intended, dramatically reducing comfortable viewing time from minutes to mere seconds. These issues disproportionately affect women and younger users under 30 years old, who typically have smaller IPD measurements.

Some AR device manufacturers have attempted to address these challenges by incorporating built-in eye-tracking sensors directly into their headsets to automatically measure IPD. However, these implementations are complex, and thus expensive to implement, and present their own set of technical drawbacks. The integration of specialized sensors significantly increases manufacturing costs and device complexity. Additionally, the positioning of these sensors within the headset itself can lead to less reliable measurements due to various factors including sensor placement constraints and the potential interference from the form factor of the device.

Existing solutions, such as manual adjustment dials found on some AR headsets, provide limited precision and rely heavily on user trial and error. While some AR devices use automatic calibration systems, these solutions typically require expensive hardware components and may still produce suboptimal results. The lack of an accessible, accurate, and cost-effective method for IPD measurement represents a significant technical barrier to widespread AR adoption and optimal user experience, particularly for demographic groups with smaller IPD measurements.

To address these technical challenges, various embodiments provide an innovative solution that leverages the widespread availability of mobile devices to create an accessible, accurate, and user-friendly IPD measurement system. By integrating sophisticated computer vision algorithms with common smartphone hardware components, these approaches offer practical alternatives to traditional measurement methods while maintaining professional-grade accuracy.

Some embodiments implement a comprehensive mobile application-based measurement system that seamlessly integrates with the initial setup and pairing process of AR eyewear. This integration represents a significant advancement over conventional approaches by eliminating separate configuration steps that might otherwise create friction in the user experience. The system may utilize various sensing technologies available on modern mobile devices, including standard RGB cameras with computer vision algorithms, structured light systems like the TrueDepth camera from Apple®, or other depth-sensing technologies. These sensors, combined with proprietary computer vision algorithms, can capture and analyze facial features for IPD measurement while simultaneously considering factors such as facial geometry and depth perception to ensure accurate results.

The system provides an intuitive guided measurement process through the mobile interface. Users may be presented with clear, step-by-step instructions and dynamic real-time feedback for achieving optimal positioning relative to the device sensors. For devices equipped with structured light technology, the system may employ infrared dot projection and IR cameras to generate precise 3D depth maps of the user's face. Alternatively, devices using standard RGB cameras may leverage computer vision landmark detection approaches to identify key facial features. The system continuously monitors the user's position, automatically detecting when adjustments are needed and providing specific guidance to achieve ideal measurement conditions.

The system offers a flexible, multi-pathway approach to IPD configuration that accommodates various user scenarios and preferences. While the primary method may involve automated measurement using the device's available sensors and computer vision technology, the system recognizes that some users may already possess accurate IPD measurements from professional sources such as optometrists or eye care specialists. In these cases, the system provides a streamlined manual entry option, allowing users to bypass the automated process entirely while still maintaining the benefits of the system's integration with the AR device.

Various embodiments leverage different combinations of sensing technologies and computer vision algorithms to perform comprehensive facial analysis. For devices with advanced depth-sensing capabilities, the system may utilize infrared emitters and cameras to create detailed 3D facial maps. For devices with standard cameras, the system may employ computer vision landmark detection combined with depth map refinement to correct for head tilt and perspective distortion. Rather than simply measuring the distance between pupils, these approaches consider multiple facial features and geometric relationships to enhance measurement accuracy.

The system implements an approach to IPD data management, where measurements are cached and stored as part of a comprehensive user profile rather than being limited to storage on the AR device itself. This architectural decision provides several advantages, including the ability to seamlessly synchronize settings across multiple devices, maintain measurement history, and facilitate ongoing optimization of the user experience. Users may have the ability to fine-tune their IPD settings through the mobile interface at any time, with the system maintaining a persistent record of adjustments and preferences.

Through this comprehensive and user-centric approach, these implementations may provide significant advantages over conventional solutions. The system potentially reduces or eliminates the need for expensive specialized hardware while maintaining or improving measurement accuracy through the use of existing mobile device sensors. Additionally, the integration with mobile devices and the intuitive user interface may significantly lower the barrier to entry for AR technology adoption, potentially expanding the accessibility of AR experiences to a broader user base. Other aspects and advantages of various embodiments of the invention will be readily apparent from the detailed descriptions of the several figures that follow.

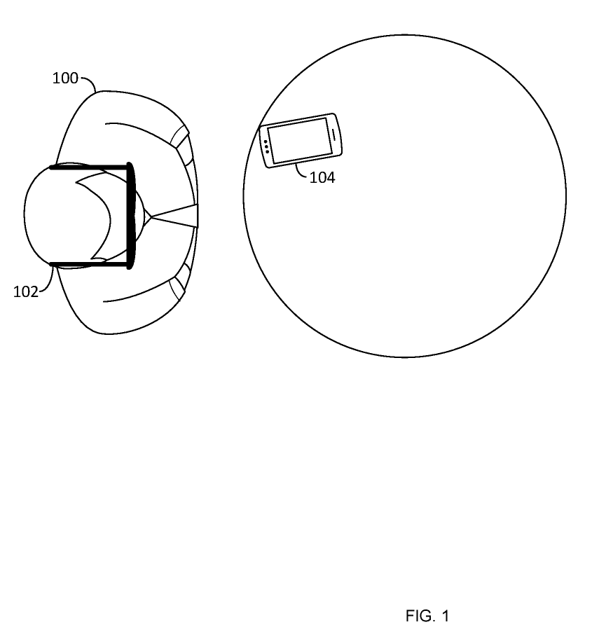

FIG. 1 is a diagram illustrating components of an augmented reality (AR) system including AR eyewear 102 and a mobile computing device 104 configured to measure interpupillary distance of a user 100, consistent with some embodiments. The AR eyewear 102 may be configured to display virtual content to a user in a manner that appears to coexist with the physical environment. The mobile computing device 104 includes various sensors and processing capabilities for determining the IPD measurement of the user, which is important for properly rendering AR content at correct depths and creating comfortable viewing experiences.

In operation, the mobile computing device 104 executes an application that guides the user through an IPD measurement process during the initial setup of the AR eyewear 102. The application may utilize a depth sensing system of the device 104, which can include components such as image sensors, structured light projectors, infrared cameras, and flood illuminators, to capture and analyze facial features. The application provides real-time feedback to help users achieve optimal positioning relative to the sensors of the device 104, ensuring accurate measurements.

The mobile computing device 104 may employ various sensing technologies to perform the IPD measurement, including standard RGB cameras with computer vision algorithms or more advanced depth sensing systems like structured light technology. These measurements are then processed using computer vision algorithms that consider not only the distance between pupils but also the overall facial geometry and shape of the face of the user.

Once the IPD measurement is determined, the mobile computing device 104 transmits this information to the AR eyewear 102, which uses the measurement to properly align virtual content with the natural stereoscopic vision of the user. This alignment is particularly important for hand-based user interfaces and other interactive AR elements, where precise depth perception is essential for comfortable and effective interaction with virtual content.

While FIG. 1 illustrates the IPD measurement system being implemented using a mobile computing device 104, in some embodiments, the measurement and configuration functionality may be implemented using other types of computing devices equipped with suitable image sensors and depth sensing capabilities. For example, laptop computers with built-in cameras and depth sensors, desktop computers with connected imaging peripherals, or other computing devices having the requisite sensing and processing capabilities may be used to perform the IPD measurements and configure the AR device 102. The measurement techniques and user interface workflows described herein may be adapted for different form factors while maintaining the core functionality of accurate IPD measurement and AR device configuration.

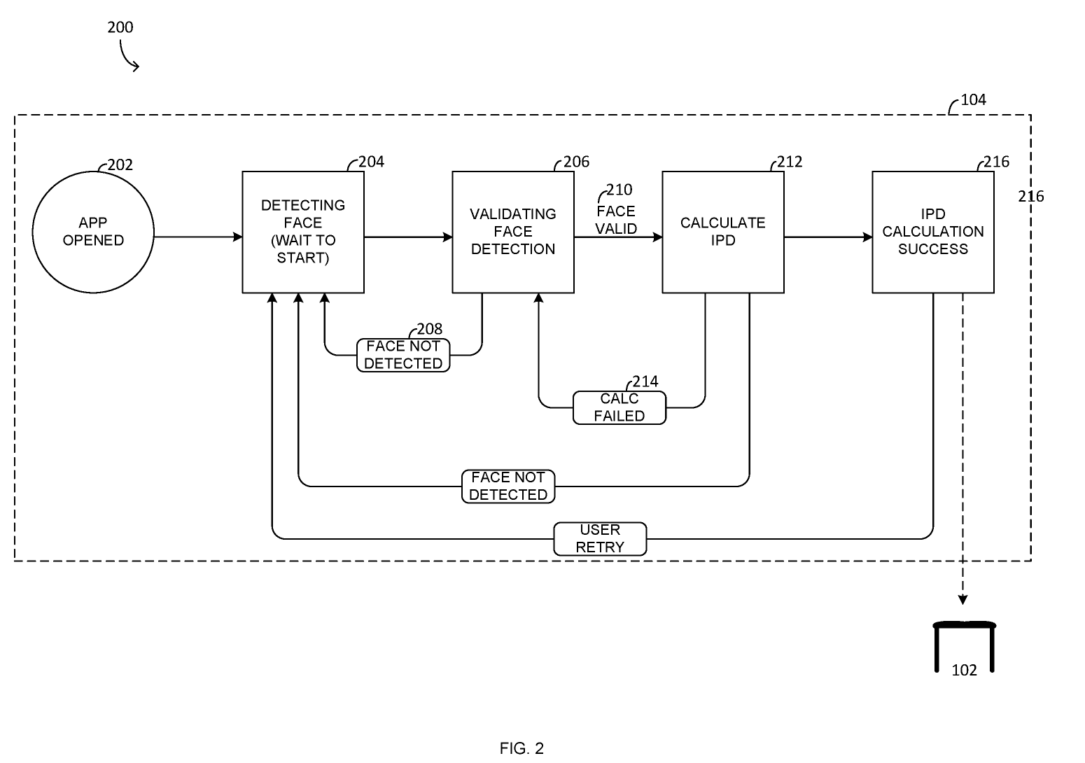

FIG. 2 illustrates a state machine 200 implemented by an application executing on computing device 104 for measuring IPD during initial AR device setup. The state machine begins when the application is opened at state 202, typically during the out-of-box experience setup flow for the AR device 102. During this initial setup, the computing device 104 establishes wireless communication with the AR device 102 to enable configuration data transfer.

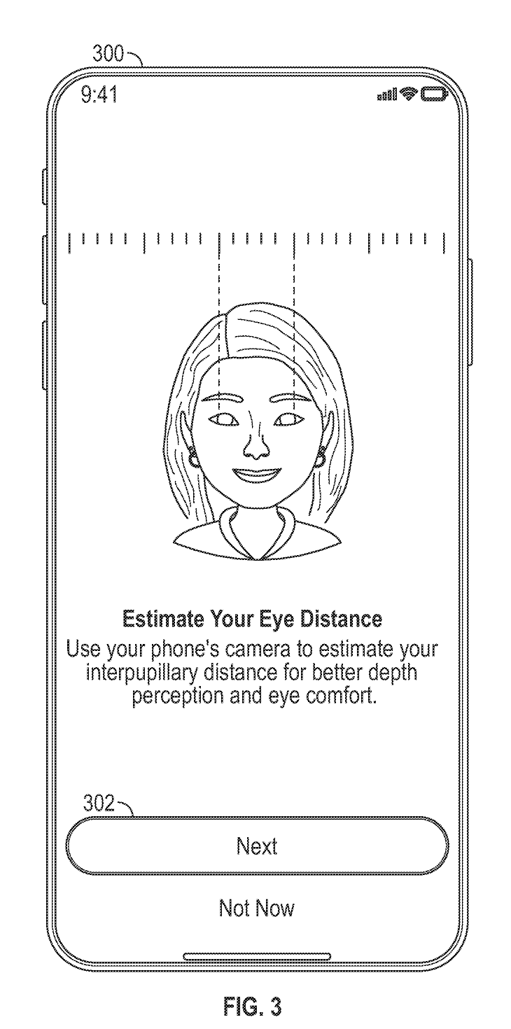

Referring briefly now to FIG. 3, a first user interface 300 of the flow for calculating the IPD and configuring the AR device is presented. This interface initiates an interactive measurement workflow that guides users through a series of screens corresponding to different states in the state machine of FIG. 2. The interface includes explanatory text about using the phone's camera for IPD measurement and its importance for depth perception and comfort. A prominent "Next" button 302 allows users to proceed with the measurement process, while a "Not Now" option enables deferring the measurement to a later time.

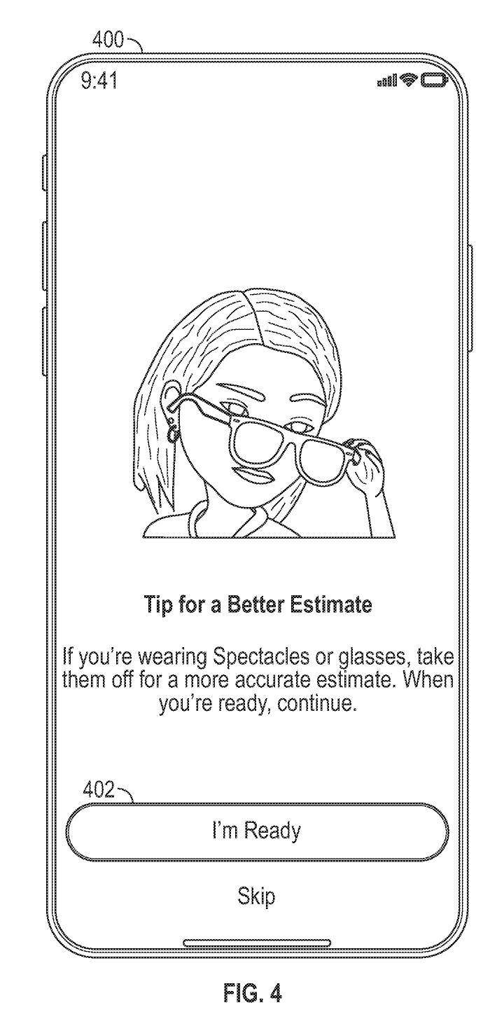

The user interface 400 shown in FIG. 4 provides critical preparation guidance for accurate measurement. The interface presents clear instructions for users to remove any existing spectacles or glasses before proceeding with the measurement process. The "I'm Ready" button 402 allows users to confirm they have followed the preparation instructions and are ready to begin the measurement process.

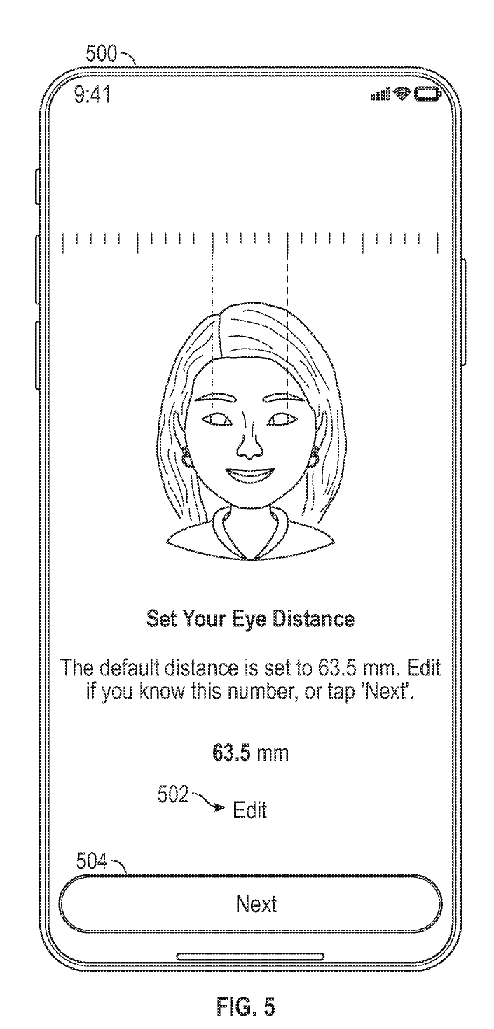

The interface 500 shown in FIG. 5 provides users with measurement options. A default IPD value of 63.5mm is displayed, along with two interaction paths: users can either select the "Edit" button 502 to manually input a known IPD value, or choose the "Next" button 504 to proceed with automated measurement using the device's depth sensing system.

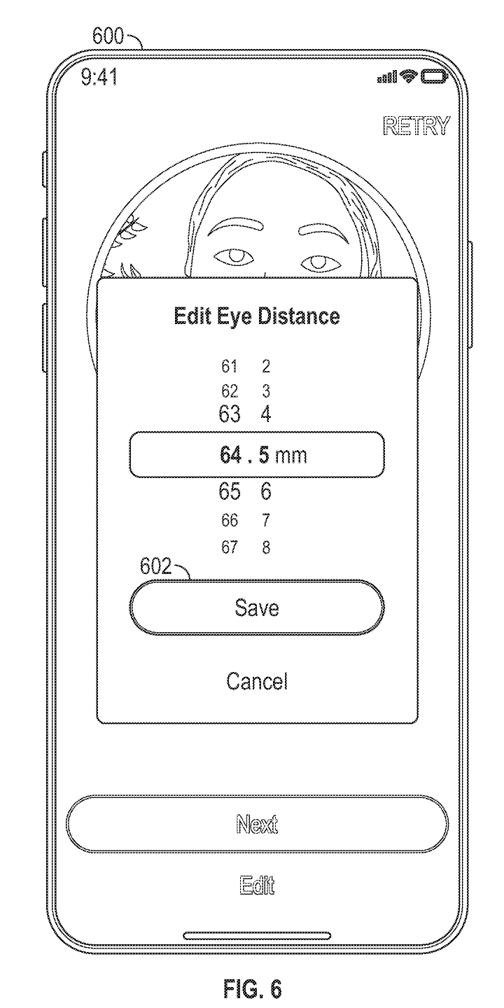

For users who choose to manually input their IPD, the interface 600 shown in FIG. 6 provides a precise adjustment mechanism. Users can fine-tune their IPD measurement using a slider interface, and the "Save" button 602 commits the manually entered value to the system.

Referring again to FIG. 2, upon selection of button 504 to perform the IPD calculation, the application activates the depth sensing system of computing device 104, which may comprise one or more of a structured light projector, infrared camera, and flood illuminator. The system enters a face detection state 204 where it continuously monitors for the face of the user. If no face is detected, a "FACE NOT DETECTED" status 208 is generated and the system continues monitoring. The application provides real-time guidance through the display to help users achieve proper positioning.

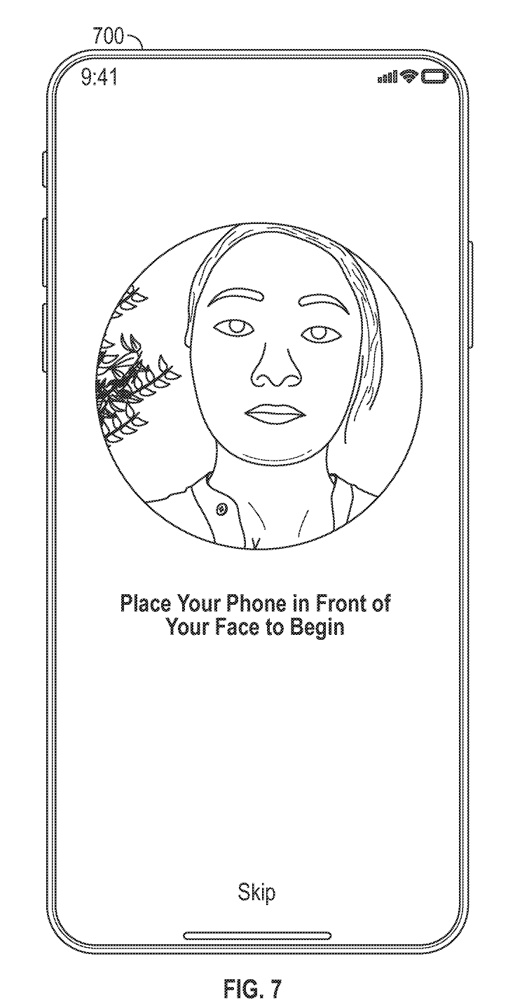

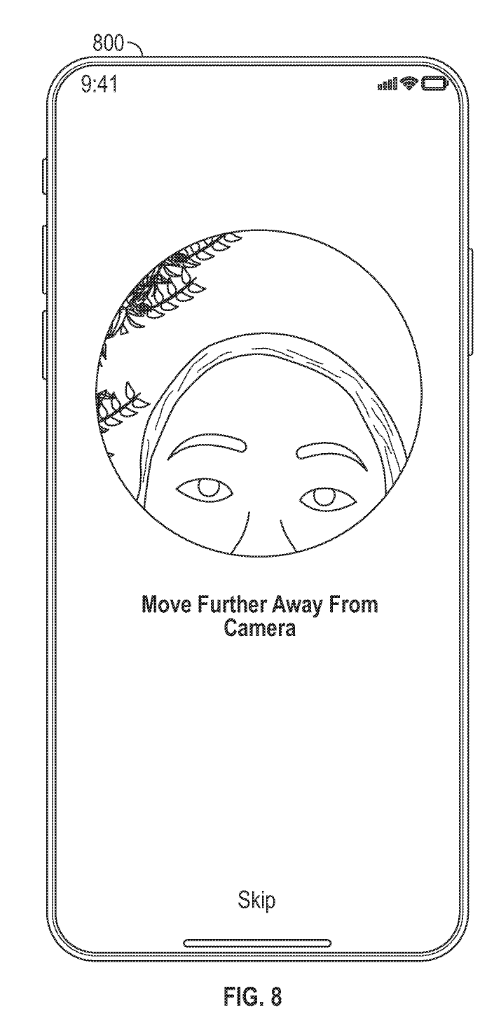

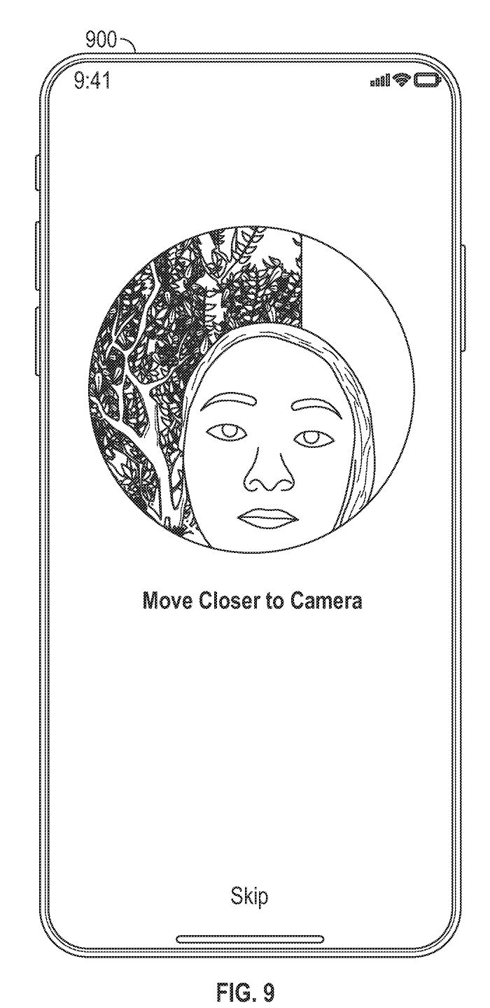

Referring now to FIG. 7, during the face detection state, the interface provides visual guidance for proper face positioning. The system may display various visual indicators including a circular frame around the detected face, color-coded feedback (such as red for improper positioning, yellow for almost correct, and green for optimal position), and animated guides. The interface can transition to showing "Move Further Away" (FIG. 8) or "Move Closer" (FIG. 9) instructions based on the user's position relative to optimal measurement distance.

Referring again to FIG. 2, once a face is detected, the system transitions to a validation state 206 where it verifies the face position relative to predetermined minimum and maximum distance thresholds from the device sensors. The application provides dynamic feedback, instructing users to move closer or further from the camera as needed. When proper positioning is achieved, indicated by "FACE VALID" status 210, the system proceeds to calculate the IPD measurement at state 212.

During the IPD calculation state 212, the system captures multiple facial depth measurements over a predetermined duration. For each measurement, the system illuminates the user's face using the flood illuminator, projects structured light patterns using the structured light projector and captures infrared images of the projected patterns. The computer vision algorithms analyze these measurements along with facial geometry and shape to calculate individual IPD values.

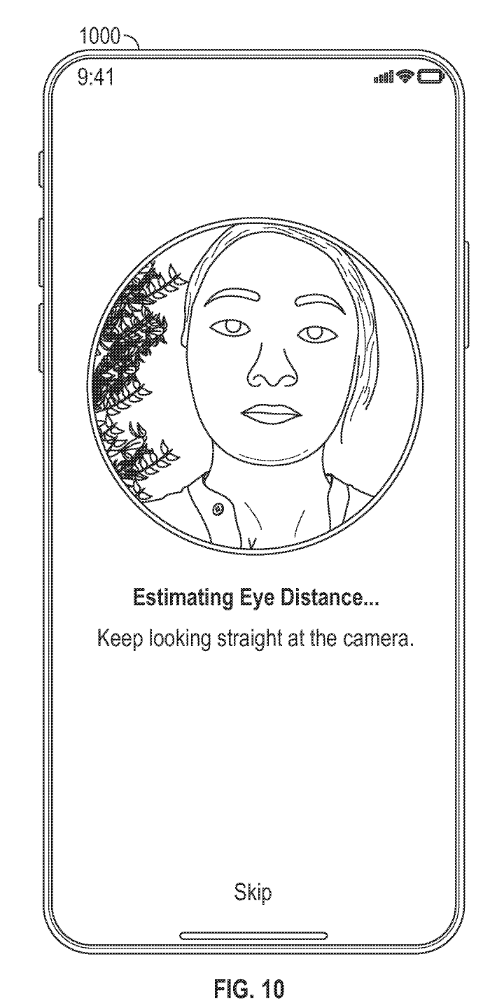

Referring now to FIG. 10, during the IPD calculation state, the interface 1000 displays a progress indicator while multiple measurements are being captured. The interface instructs users to maintain steady eye contact with the camera and includes visual feedback showing the measurement is in progress.

During measurement, the depth sensing system projects a pattern of infrared dots onto the user's face, which are captured by the infrared camera. The system analyzes the deformation of this projected pattern to create a detailed 3D map of facial features. Multiple depth measurements are taken to account for minor movements and ensure accuracy. The system also considers the overall shape of the user's face and facial geometry when calculating the final IPD value.

Referring again to FIG. 2, if the IPD calculation fails, indicated by "CALC FAILED" status 214, the system returns to the face detection state 204. Upon successful calculation, reaching the "IPD CALCULATION SUCCESS" state 216, the system determines a final IPD measurement by averaging the series of calculated measurements. The user interface displays this measurement numerically in millimeters and provides options to manually fine-tune the value or retry the measurement process entirely.

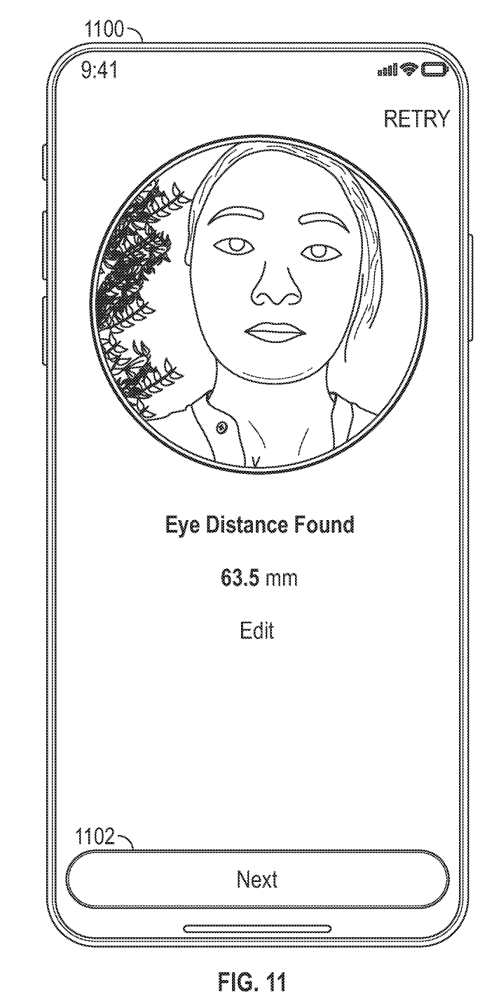

Referring now to FIG. 11, upon successful IPD calculation, the interface displays the calculated measurement with a visual confirmation indicator. The "Next" button 1102 allows users to proceed with applying the measurement to the AR device configuration.

Referring again to FIG. 2, throughout the process, the application prevents progression through the setup flow until valid IPD measurements are obtained. The final IPD measurement is stored in a user profile maintained separately from the AR device 102, enabling synchronization across multiple devices and maintaining measurement history. This profile-based approach allows for subsequent modification of the IPD measurement through the application interface.

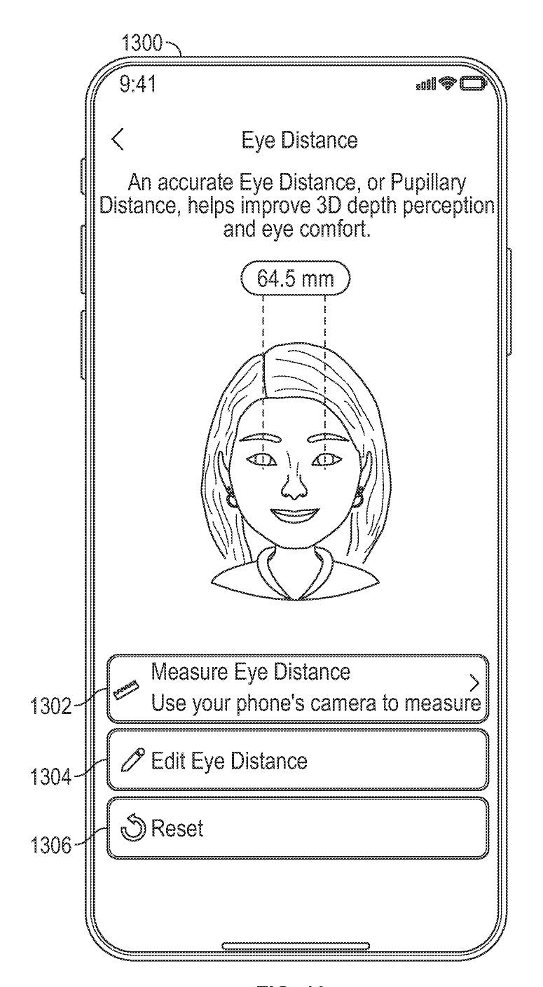

The interface shown in FIG. 13 provides comprehensive IPD management options after the initial setup. Users can access options to re-measure their IPD using the camera (1302), manually edit the existing measurement (1304), or reset to the default value (1306). This interface serves as a central hub for managing and adjusting IPD settings at any time after the initial configuration.

### EXAMPLE AUGMENTED REALITY (AR) DEVICE

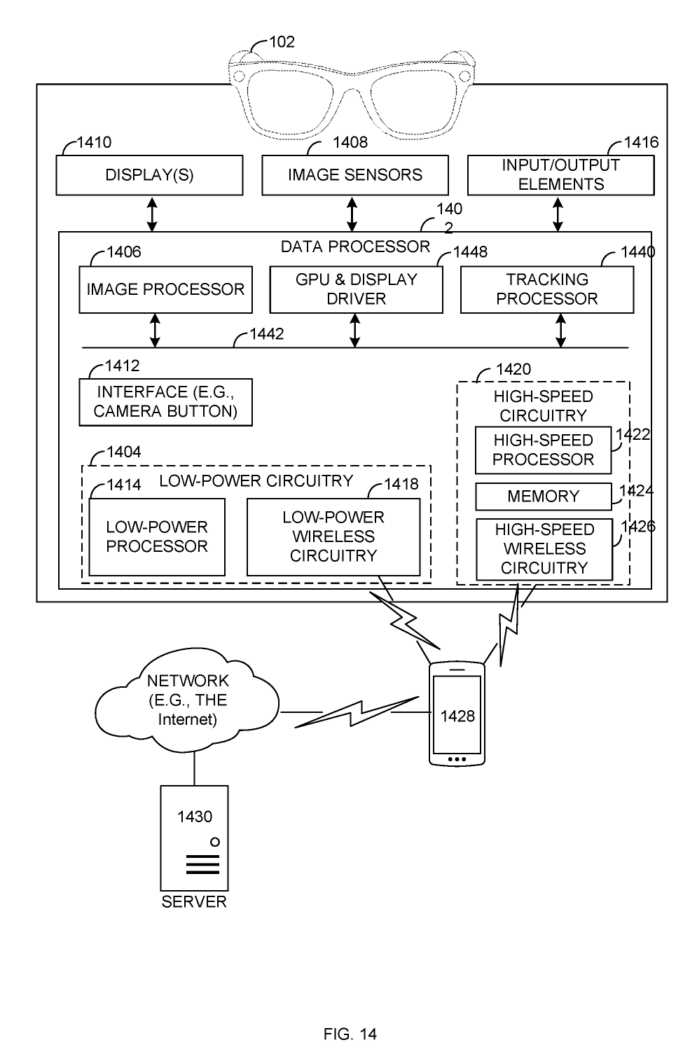

FIG. 14 is a block diagram illustrating an example of the functional components (e.g., hardware components) of an AR device (e.g., AR glasses 102) with which the methods and techniques described herein, may be implemented, consistent with embodiments of the present invention. Those skilled in the art will readily appreciate that the AR glasses 102 depicted in FIG. 14 are but one example of the many different devices to which the inventive subject matter may be applicable. For example, embodiments of the present invention are not limited to AR glasses, but are also applicable to AR headsets, and other wearable virtual reality devices and mixed reality devices.

The AR glasses 102 include a data processor 1402, a display 1410, two or more image sensors 1408, and additional input/output elements 1416. The input/output elements 1416 may include microphones, audio speakers, biometric sensors, additional sensors, or additional display elements integrated with the data processor 1402. For example, the input/output elements 1416 may include any of I/O components, including motion components, and so forth.

Consistent with one example, and as described herein, the display 1410 includes a first sub-display for the user’s left eye and a second sub-display for the user’s right eye. Accordingly, although referenced in the singular (a display), the display may, in some examples, comprises two separate displays that operate together. Each display of the AR glasses 102 may include a forward optical assembly (not shown) comprising a right projector and a right near eye display, and a forward optical assembly including a left projector and a left near eye display. In some examples, the near eye displays are waveguides. The waveguides include reflective or diffractive structures (e.g., gratings and/or optical elements such as mirrors, lenses, or prisms). Light emitted by the right projector encounters the diffractive structures of the waveguide of the right near eye display, which directs the light towards the right eye of a user to provide an image on or in the right optical element that overlays the view of the real world seen by the user. Similarly, light emitted by a left projector encounters the diffractive structures of the waveguide of the left near eye display, which directs the light towards the left eye of a user to provide an image on or in the left optical element that overlays the view of the real world seen by the user.

The data processor 1402 includes an image processor 1406 (e.g., a video processor), a graphics processor unit (GPU) & display driver 1448, a tracking processor 1440, an interface 1412, low-power circuitry 1404, and high-speed circuitry 1420. The components of the data processor 1402 are interconnected by a bus 1442.

The interface 1412 refers to any source of a user command that is provided to the data processor 1402 as input. In one or more examples, the interface 1412 is a physical button that, when depressed, sends a user input signal from the interface 1412 to a low-power processor 1414. A depression of such button followed by an immediate release may be processed by the low-power processor 1414 as a request to capture a single image, or vice versa. A depression of such a button for a first period of time may be processed by the low-power processor 1414 as a request to capture video data while the button is depressed, and to cease video capture when the button is released, with the video captured while the button was depressed stored as a single video file. Alternatively, depression of a button for an extended period of time may capture a still image. In some examples, the interface 1412 may be any mechanical switch or physical interface capable of accepting and detecting user inputs associated with a request for data from the image sensor(s) 1408. In other examples, the interface 1412 may have a software component, or may be associated with a command received wirelessly from another source, such as from the client device 1428.

The image processor 1406 includes circuitry to receive signals from the image sensors 1408 and process those signals from the image sensors 1408 into a format suitable for storage in the memory 1424 or for transmission to the client device 1428. In one or more examples, the image processor 1406 (e.g., video processor) comprises a microprocessor integrated circuit (IC) customized for processing sensor data from the image sensors 1408, along with volatile memory used by the microprocessor in operation.

The low-power circuitry 1404 includes the low-power processor 1414 and the low-power wireless circuitry 1418. These elements of the low-power circuitry 1404 may be implemented as separate elements or may be implemented on a single IC as part of a system on a single chip. The low-power processor 1414 includes logic for managing the other elements of the AR glasses 102. As described above, for example, the low-power processor 1414 may accept user input signals from the interface 1412. The low-power processor 1414 may also be configured to receive input signals or instruction communications from the client device 1428 via the low-power wireless connection. The low-power wireless circuitry 1418 includes circuit elements for implementing a low-power wireless communication system. Bluetooth™ Smart, also known as Bluetooth™ low energy, is one standard implementation of a low power wireless communication system that may be used to implement the low-power wireless circuitry 1418. In other examples, other low power communication systems may be used.

The high-speed circuitry 1420 includes a high-speed processor 1422, a memory 1424, and a high-speed wireless circuitry 1426. The high-speed processor 1422 may be any processor capable of managing high-speed communications and operation of any general computing system used for the data processor 1402. The high-speed processor 1422 includes processing resources used for managing high-speed data transfers on the high-speed wireless connection 1434 using the high-speed wireless circuitry 1426. In some examples, the high-speed processor 1422 executes an operating system such as a LINUX operating system or other such operating system. In addition to any other responsibilities, the high-speed processor 1422 executing a software architecture for the data processor 1402 is used to manage data transfers with the high-speed wireless circuitry 1426. In some examples, the high-speed wireless circuitry 1426 is configured to implement Institute of Electrical and Electronic Engineers (IEEE) 802.11 communication standards, also referred to herein as Wi-Fi. In other examples, other high-speed communications standards may be implemented by the high-speed wireless circuitry 1426.

The memory 1424 includes any storage device capable of storing camera data generated by the image sensors 1408 and the image processor 1406. While the memory 1424 is shown as integrated with the high-speed circuitry 1420, in other examples, the memory 1424 may be an independent standalone element of the data processor 402. In some such examples, electrical routing lines may provide a connection through a chip that includes the high-speed processor 1422 from image processor 1406 or the low-power processor 1414 to the memory 1424. In other examples, the high-speed processor 1422 may manage addressing of the memory 1424 such that the low-power processor 1414 will boot the high-speed processor 1422 any time that a read or write operation involving the memory 1424 is desired.

The tracking processor 1440 estimates a pose of the AR glasses 102. For example, the tracking processor 1440 uses image data and corresponding inertial data from the image sensors 1408 and the position components, as well as GPS data, to track a location and determine a pose of the AR glasses 102 relative to a frame of reference (e.g., real-world scene). The tracking module 1440 continually gathers and uses updated sensor data describing movements of the AR glasses 102 to determine updated three-dimensional poses of the AR glasses 102 that indicate changes in the relative position and orientation relative to physical objects in the real-world environment. The tracking processor 1440 permits visual placement of virtual objects relative to physical objects by the AR glasses 102 within the field of view of the user via the displays 1410.

The GPU & display driver 1438 may use the pose of the AR glasses 102 to generate frames of virtual content or other content to be presented on the displays 410 when the AR glasses 102 are functioning in a traditional AR mode. In this mode, the GPU & display driver 1438 generate updated frames of virtual content based on updated three-dimensional poses of the AR glasses 102, which reflect changes in the position and orientation of the user in relation to physical objects in the user’s real-world environment.

One or more functions or operations described herein may also be performed in an application resident on the AR glasses 102 or on the client device 1428, or on a remote server 1430. Consistent with some examples, the AR glasses 102 may operate in a networked system, which includes the AR glasses 102, the client computing device 1428, and a server 1430, which may be communicatively coupled via the network. The client device 1428 may be a smartphone, tablet, phablet, laptop computer, access point, or any other such device capable of connecting with the AR glasses 102 using a low-power wireless connection and/or a high-speed wireless connection. The client device 1428 is connected to the server system 1430 via the network. The network may include any combination of wired and wireless connections. The server 1430 may be one or more computing devices as part of a service or network computing system.

### SOFTWARE ARCHITECTURE

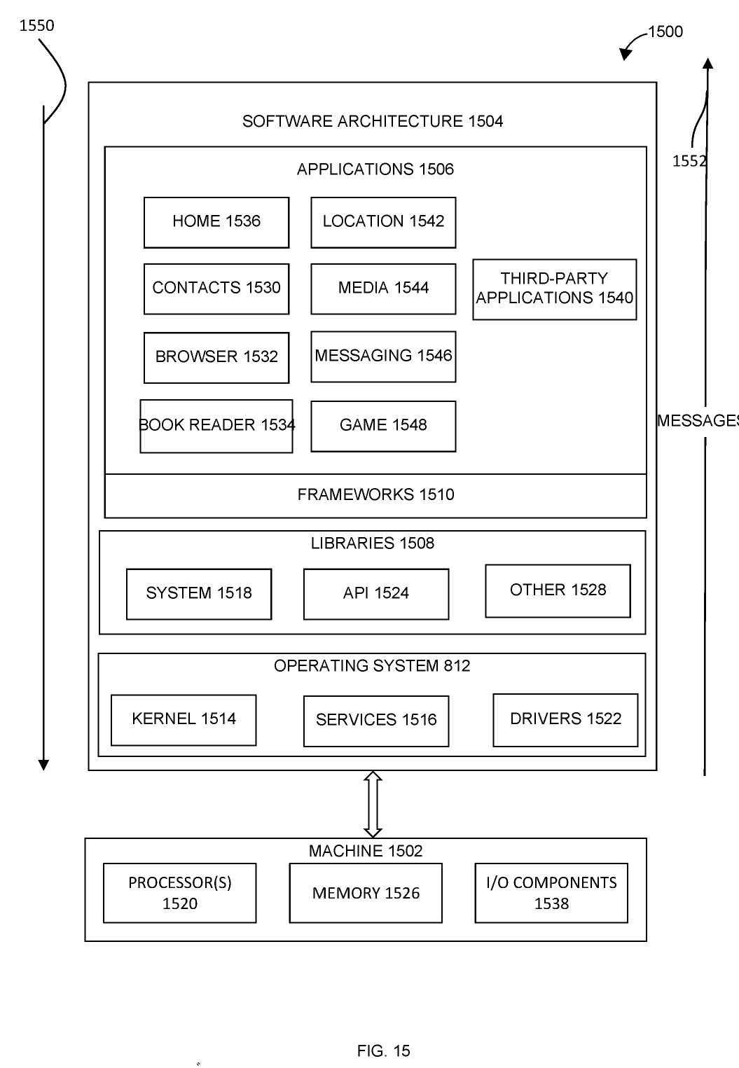

FIG. 15 is a block diagram 1500 illustrating a software architecture 1504, which can be installed on any one or more of the devices described herein. The software architecture 1504 is supported by hardware such as a machine 1502 that includes processors 1520, memory 1526, and I/O components 1538. In this example, the software architecture 1504 can be conceptualized as a stack of layers, where individual layers provides a particular functionality. The software architecture 1504 includes layers such as an operating system 1512, libraries 1508, frameworks 1510, and applications 1506. Operationally, the applications 1506 invoke API calls 1550 through the software stack and receive messages 1552 in response to the API calls 1550.

The operating system 1512 manages hardware resources and provides common services. The operating system 1512 includes, for example, a kernel 1514, services 1516, and drivers 1522. The kernel 1514 acts as an abstraction layer between the hardware and the other software layers. For example, the kernel 1514 provides memory management, processor management (e.g., scheduling), component management, networking, and security settings, among other functionalities. The services 1516 can provide other common services for the other software layers. The drivers 1522 are responsible for controlling or interfacing with the underlying hardware. For instance, the drivers 1522 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1508 provide a low-level common infrastructure used by the applications 1506. The libraries 1508 can include system libraries 1518 (e.g., C standard library) that provide functions such as memory allocation functions, string manipulation functions, mathematic functions, and the like. In addition, the libraries 1508 can include API libraries 1524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement 3D user interfaces), image feature extraction libraries (e.g. OpenIMAJ), database libraries (e.g., SQLite to provide various relational database functions), web libraries (e.g., WebKit to provide web browsing functionality), and the like. The libraries 1508 can also include a wide variety of other libraries 1528 to provide many other APIs to the applications 1506.

The frameworks 1510 provide a high-level common infrastructure that is used by the applications 1506. For example, the frameworks 1510 provide various graphical user interface (GUI) functions, high-level resource management, and high-level location services. The frameworks 1510 can provide a broad spectrum of other APIs that can be used by the applications 1506, some of which may be specific to a particular operating system or platform.

In an example, the applications 1506 may include a home application 1536, a contacts application 1530, a browser application 1532, a book reader application 1534, a location application 1542, a media application 1544, a messaging application 1546, a game application 1548, and a broad assortment of other Applications such as third-party applications 1540. The applications 1506 are programs that execute functions defined in the programs. Various programming languages can be employed to create one or more of the applications 1506, structured in a variety of manners, such as object-oriented programming languages (e.g., Objective-C, Java, or C++) or procedural programming languages (e.g., C or assembly language). In a specific example, the third-party applications 1540 (e.g., Applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party applications 1540 can invoke the API calls 1550 provided by the operating system 1512 to facilitate functionality described herein.

### EXAMPLES

Example 1 is a method for configuring an augmented reality (AR) device using a computing device having an image sensor and a depth sensing system, the method comprising: receiving, at an application executing on the computing device, a request to determine an interpupillary distance (IPD) measurement during an initial setup process of the AR device; displaying, via the application, instructions for positioning a user’s face relative to an image sensor of the computing device; activating a depth sensing system of the computing device, wherein the depth sensing system comprises at least one of: a structured light projector, an infrared camera, and a flood illuminator; detecting the face of the user using the depth sensing system; validating that the detected face of the user is positioned within predetermined minimum and maximum distance thresholds from the image sensor; upon validating the face position: capturing a series of facial depth measurements over a predetermined duration; calculating an IPD measurement for each captured facial depth measurement using computer vision algorithms; determining a final IPD measurement by averaging the calculated IPD measurements; and transmitting over a wireless network the final IPD measurement to the AR device for calibrating the AR device.

In Example 2, the subject matter of Example 1 includes, displaying, via the application during the capturing of facial depth measurements, real-time positioning guidance including at least one of: an indication instructing the user to move closer to the image sensor when the detected face is beyond the maximum distance threshold; an indication instructing the user to move further from the image sensor when the detected face is closer than the minimum distance threshold; and a confirmation indicator when the detected face of the user is within the predetermined distance thresholds.

In Example 3, the subject matter of Examples 1–2 includes, prior to activating the depth sensing system: displaying an option to manually input a known IPD measurement; receiving, via the application, a user selection to manually input the known IPD measurement; and in response to receiving the user selection, displaying a user interface for manually entering the known IPD measurement instead of performing the facial depth measurements.

In Example 4, the subject matter of Examples 1–3 includes, storing the final IPD measurement in association with a user profile maintained separately from the AR device, wherein the user profile enables: synchronization of the IPD measurement across multiple AR devices; maintaining a history of IPD measurements; and subsequent modification of the IPD measurement via the application.

In Example 5, the subject matter of Examples 1–4 includes, displaying, prior to activating the depth sensing system, a prompt requesting removal of any existing augmented reality glasses.

In Example 6, the subject matter of Examples 1–5 includes, wherein calculating the IPD measurement comprises: analyzing facial geometry of the detected face; determining a shape of the user's face; and adjusting the IPD measurement based on the determined facial geometry and shape.

In Example 7, the subject matter of Examples 1–6 includes, wherein displaying instructions comprises: presenting an avatar-based visualization showing proper face positioning relative to the computing device.

In Example 8, the subject matter of Examples 1–7 includes, wherein validating the face position comprises: displaying a circular interface element surrounding a representation of the detected face; updating the circular interface element to indicate when proper positioning is achieved.

In Example 9, the subject matter of Examples 1–8 includes, displaying a slider interface for manually adjusting the final IPD measurement; and receiving, via the slider interface, fine-tuning adjustments to the final IPD measurement.

In Example 10, the subject matter of Examples 1–9 includes, wherein capturing the series of facial depth measurements comprises: illuminating the face of the user using a flood illuminator; projecting structured light patterns onto the face of the user; and capturing infrared images of the projected patterns.

In Example 11, the subject matter of Examples 1–10 includes, displaying a numerical representation of the final IPD measurement in millimeters; and providing a reset option to restart the measurement process.

In Example 12, the subject matter of Examples 1–11 includes, wherein the application is configured to: display the instructions during an out-of-box experience (OOBE) setup flow for the AR device; and prevent progression through the setup flow until valid IPD measurements are obtained.

Example 13 is a system comprising: at least one processor; a display configured to present user interface elements and instructions; a depth sensing system comprising at least one of: a structured light projector, an infrared camera, and a flood illuminator; a network communications interface configured to communicate with an augmented reality (AR) device; and at least one memory storage device storing instructions that, when executed by the at least one processor, cause the system to perform operations comprising: receiving, via the display, a request to determine an interpupillary distance (IPD) measurement during an initial setup process of the AR device; displaying, via the display, instructions for positioning a user's face relative to the depth sensing system; activating the depth sensing system; detecting, using the depth sensing system, the face of the user; validating, using the depth sensing system, that the detected face is positioned within predetermined minimum and maximum distance thresholds; upon validating the face position: capturing, using the depth sensing system, a series of facial depth measurements over a predetermined duration; calculating, using the processor, an IPD measurement for each captured facial depth measurement using computer vision algorithms; determining, using the processor, a final IPD measurement by averaging the calculated IPD measurements; and transmitting, via the network communications interface, the final IPD measurement to the AR device for calibrating the AR device.

In Example 14, the subject matter of Example 13 includes, wherein the instructions further cause the system to: display, during the capturing of facial depth measurements, real-time positioning guidance including at least one of: an indication instructing the user to move closer to the computing device when the detected face is beyond the maximum distance threshold; an indication instructing the user to move further from the computing device when the detected face is closer than the minimum distance threshold; and a confirmation indicator when the detected face is within the predetermined distance thresholds.

In Example 15, the subject matter of Examples 13–14 includes, wherein the instructions further cause the system to: display an option to manually input a known IPD measurement prior to activating the depth sensing system; receive a user selection to manually input the known IPD measurement; and in response to receiving the user selection, display a user interface for manually entering the known IPD measurement instead of performing the facial depth measurements.

In Example 16, the subject matter of Examples 13–15 includes, wherein the instructions further cause the system to: store the final IPD measurement in association with a user profile maintained separately from the AR device, wherein the user profile enables: synchronization of the IPD measurement across multiple AR devices; maintaining a history of IPD measurements; and subsequent modification of the IPD measurement.

In Example 17, the subject matter of Examples 13–16 includes, wherein calculating the IPD measurement comprises: analyzing facial geometry of the detected face; determining a shape of the user's face; and adjusting the IPD measurement based on the determined facial geometry and shape.

In Example 18, the subject matter of Examples 13–17 includes, wherein capturing the series of facial depth measurements comprises: illuminating the face of the user using the flood illuminator; projecting structured light patterns onto the face of the user using the structured light projector; and capturing infrared images of the projected patterns using the infrared camera.

In Example 19, the subject matter of Examples 13–18 includes, wherein the instructions further cause the system to: display the instructions during an out-of-box experience (OOBE) setup flow for the AR device; and prevent progression through the setup flow until valid IPD measurements are obtained.

Example 20 is a non-transitory computer-readable storage medium storing instructions that, when executed by at least one processor of a computing device having a display, a depth sensing system, and a network communications interface, cause the computing device to perform operations comprising: receiving a request to determine an interpupillary distance (IPD) measurement during an initial setup process of an augmented reality (AR) device; displaying, via the display, instructions for positioning a user's face relative to the depth sensing system; activating the depth sensing system, wherein the depth sensing system comprises at least one of: a structured light projector, an infrared camera, and a flood illuminator; detecting, using the depth sensing system, the face of the user; validating, using the depth sensing system, that the detected face is positioned within predetermined minimum and maximum distance thresholds; upon validating the face position: capturing, using the depth sensing system, a series of facial depth measurements over a predetermined duration; calculating, using the at least one processor, an IPD measurement for each captured facial depth measurement using computer vision algorithms; determining, using the at least one processor, a final IPD measurement by averaging the calculated IPD measurements; and transmitting, via the network communications interface, the final IPD measurement to the AR device for calibrating the AR device.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components, also referred to as “computer-implemented.” Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A method for configuring an augmented reality (AR) device using a computing device having an image sensor and a depth sensing system, the method comprising:
receiving, at an application executing on the computing device, a request to determine an interpupillary distance (IPD) measurement during an initial setup process of the AR device;
displaying, via the application, instructions for positioning a user’s face relative to an image sensor of the computing device;
activating a depth sensing system of the computing device, wherein the depth sensing system comprises at least one of: a structured light projector, an infrared camera, and a flood illuminator;
detecting the face of the user using the depth sensing system;
validating that the detected face of the user is positioned within predetermined minimum and maximum distance thresholds from the image sensor;
upon validating the face position:
capturing a series of facial depth measurements over a predetermined duration;
calculating an IPD measurement for each captured facial depth measurement using computer vision algorithms;
determining a final IPD measurement by averaging the calculated IPD measurements; and
transmitting over a wireless network the final IPD measurement to the AR device for calibrating the AR device.

2. The method of claim 1, further comprising:
displaying, via the application during the capturing of facial depth measurements, real-time positioning guidance including at least one of:
an indication instructing the user to move closer to the image sensor when the detected face is beyond the maximum distance threshold;
an indication instructing the user to move further from the image sensor when the detected face is closer than the minimum distance threshold; and
a confirmation indicator when the detected face of the user is within the predetermined distance thresholds.

3. The method of claim 1, further comprising:
prior to activating the depth sensing system:
displaying an option to manually input a known IPD measurement;
receiving, via the application, a user selection to manually input the known IPD measurement; and
in response to receiving the user selection, displaying a user interface for manually entering the known IPD measurement instead of performing the facial depth measurements.

4. The method of claim 1, further comprising:
storing the final IPD measurement in association with a user profile maintained separately from the AR device, wherein the user profile enables:
synchronization of the IPD measurement across multiple AR devices;
maintaining a history of IPD measurements; and
subsequent modification of the IPD measurement via the application.

5. The method of claim 1, further comprising:
displaying, prior to activating the depth sensing system, a prompt requesting removal of any existing augmented reality glasses.

6. The method of claim 1, wherein calculating the IPD measurement comprises:
analyzing facial geometry of the detected face;
determining a shape of the user's face; and
adjusting the IPD measurement based on the determined facial geometry and shape.

7. The method of claim 1, wherein displaying instructions comprises:
presenting an avatar-based visualization showing proper face positioning relative to the computing device.

8. The method of claim 1, wherein validating the face position comprises:
displaying a circular interface element surrounding a representation of the detected face;
updating the circular interface element to indicate when proper positioning is achieved.

9. The method of claim 1, further comprising:
displaying a slider interface for manually adjusting the final IPD measurement; and
receiving, via the slider interface, fine-tuning adjustments to the final IPD measurement.

10. The method of claim 1, wherein capturing the series of facial depth measurements comprises:
illuminating the face of the user using a flood illuminator;
projecting structured light patterns onto the face of the user; and
capturing infrared images of the projected patterns.

11. The method of claim 1, further comprising:
displaying a numerical representation of the final IPD measurement in millimeters; and
providing a reset option to restart the measurement process.

12. The method of claim 1, wherein the application is configured to:
display the instructions during an out-of-box experience (OOBE) setup flow for the AR device; and
prevent progression through the setup flow until valid IPD measurements are obtained.

13. A system comprising:
at least one processor;
a display configured to present user interface elements and instructions;
a depth sensing system comprising at least one of: a structured light projector, an infrared camera, and a flood illuminator;
a network communications interface configured to communicate with an augmented reality (AR) device; and
at least one memory storage device storing instructions that, when executed by the at least one processor, cause the system to perform operations comprising:
receiving, via the display, a request to determine an interpupillary distance (IPD) measurement during an initial setup process of the AR device;
displaying, via the display, instructions for positioning a user's face relative to the depth sensing system;
activating the depth sensing system;
detecting, using the depth sensing system, the face of the user;
validating, using the depth sensing system, that the detected face is positioned within predetermined minimum and maximum distance thresholds;
upon validating the face position:
capturing, using the depth sensing system, a series of facial depth measurements over a predetermined duration;
calculating, using the processor, an IPD measurement for each captured facial depth measurement using computer vision algorithms;
determining, using the processor, a final IPD measurement by averaging the calculated IPD measurements; and
transmitting, via the network communications interface, the final IPD measurement to the AR device for calibrating the AR device.

14. The system of claim 13, wherein the instructions further cause the system to:
display, during the capturing of facial depth measurements, real-time positioning guidance including at least one of:
an indication instructing the user to move closer to the computing device when the detected face is beyond the maximum distance threshold;
an indication instructing the user to move further from the computing device when the detected face is closer than the minimum distance threshold; and
a confirmation indicator when the detected face is within the predetermined distance thresholds.

15. The system of claim 13, wherein the instructions further cause the system to:
display an option to manually input a known IPD measurement prior to activating the depth sensing system;
receive a user selection to manually input the known IPD measurement; and
in response to receiving the user selection, display a user interface for manually entering the known IPD measurement instead of performing the facial depth measurements.

16. The system of claim 13, wherein the instructions further cause the system to:
store the final IPD measurement in association with a user profile maintained separately from the AR device, wherein the user profile enables:
synchronization of the IPD measurement across multiple AR devices;
maintaining a history of IPD measurements; and
subsequent modification of the IPD measurement.

17. The system of claim 13, wherein calculating the IPD measurement comprises:
analyzing facial geometry of the detected face;
determining a shape of the user's face; and
adjusting the IPD measurement based on the determined facial geometry and shape.

18. The system of claim 13, wherein capturing the series of facial depth measurements comprises:
illuminating the face of the user using the flood illuminator;
projecting structured light patterns onto the face of the user using the structured light projector; and
capturing infrared images of the projected patterns using the infrared camera.

19. The system of claim 13, wherein the instructions further cause the system to:
display the instructions during an out-of-box experience (OOBE) setup flow for the AR device; and
prevent progression through the setup flow until valid IPD measurements are obtained.

20. A non-transitory computer-readable storage medium storing instructions that, when executed by at least one processor of a computing device having a display, a depth sensing system, and a network communications interface, cause the computing device to perform operations comprising:
receiving a request to determine an interpupillary distance (IPD) measurement during an initial setup process of an augmented reality (AR) device;
displaying, via the display, instructions for positioning a user's face relative to the depth sensing system;
activating the depth sensing system, wherein the depth sensing system comprises at least one of: a structured light projector, an infrared camera, and a flood illuminator;
detecting, using the depth sensing system, the face of the user;
validating, using the depth sensing system, that the detected face is positioned within predetermined minimum and maximum distance thresholds;
upon validating the face position:
capturing, using the depth sensing system, a series of facial depth measurements over a predetermined duration;
calculating, using the at least one processor, an IPD measurement for each captured facial depth measurement using computer vision algorithms;
determining, using the at least one processor, a final IPD measurement by averaging the calculated IPD measurements; and
transmitting, via the network communications interface, the final IPD measurement to the AR device for calibrating the AR device.
